(19) United States
(12) Patent Application Publication
(10) Pub. No.: US 2021/0252566 A1
(43) Pub. Date: Aug. 19, 2021

(54) MINIMIZATION OF ROCK PILE LEACHATE FORMATION AND METHODS OF TREATING ROCK PILE LEACHATES

(71) Applicant: Heritage Research Group, Indianapolis, IN (US)

(72) Inventors: Ralph E. Roper, JR., Carmel, IN (US); Anthony J. Kriech, Indianapolis, IN (US)

(73) Assignee: Heritage Research Group, Indianapolis, IN (US)

(21) Appl. No.: 17/301,987

(22) Filed: Apr. 21, 2021

Related U.S. Application Data
(63) Continuation of application No. PCT/US2019/057403, filed on Oct. 22, 2019.
(60) Provisional application No. 62/752,682, filed on Oct. 30, 2018.

(51) Int. Cl. B09B 3/00; B09C 1/10; C22B 3/18

(52) U.S. Cl. CPC B09B 3/00; C22B 3/18; B09C 1/10

(57) ABSTRACT

Methods of treating leachates in rock piles. Exemplary leachates include neutral aqueous leachates containing selenates and nitrates, said leachates being found in waste rock piles from coal mining operations. In certain embodiments, the method includes introducing an inert gas to the lower section of the rock pile, and allowing bacteria indigenous to the mining site to reduce the selenates and nitrates to selenium and nitrogen, respectively.

### CROSS REFERENCE TO RELATED APPLICATIONS

This application is a continuation of International Application No. PCT/US2019/057403 filed Oct. 22, 2019, which claims the benefit of U.S. Provisional Application No. 62/752,682 filed Oct. 24, 2018, each of which are hereby incorporated by reference herein in their entirety.

### FIELD

The present disclosure relates to methods of reducing or eliminating rock leachate formation, as well as the treatment of leachates resulting from the permeation of water through rock piles. In certain embodiments, the leachates are found in waste rock piles from mining operations (e.g., coal mining), wherein the leachates are neutral leachates containing selenates and nitrates.

### BACKGROUND

Open pit coal mining operations can produce massive quantities of waste rock. The waste rock is typically dumped in adjacent waste rock piles that continue to grow for many decades throughout the life of the mine. Piles of waste rock frequently reach heights of well over 100 meters. Because typical waste rock piles are porous and uncapped, they are subject to “weathering” whereby the infiltration of precipitation and the advection of air result in chemical corrosion, i.e., mineralization, of the rock surfaces. This can result in the production of aqueous “leachates” that contain undesirable minerals that may be toxic to the environment, such as selenates and nitrates, as well as solubilized forms of arsenic, cadmium, and zinc. Accordingly, there remains a need to develop systems to reduce or eliminate leachate formation, and/or treat the resulting leachates in an effort to remove or reduce such toxic minerals before the leachates leave the rock pile and enter the environment.

### SUMMARY

Described herein are methods of reducing or eliminating leachate formation in waste rock piles. In certain embodiments, the method comprises: identifying a waste rock material; crushing the waste rock material to produce crushed waste rock; and packing the crushed waste rock to form a rock pile, wherein the rock pile exhibits a void volume of 5% or less.

Described herein are methods of treating leachates in a rock pile. In certain embodiments, the method comprises:

identifying a site having a rock pile with a top, a bottom, an upper section, and a lower section, said lower section containing oxygen, bacteria, and an aqueous leachate, wherein the aqueous leachate comprises at least one of a selenate or a nitrate, and wherein the bacteria are indigenous to the site;

displacing at least a portion of the oxygen from the lower section of the rock pile; and

allowing the bacteria to reduce the at least one selenate or nitrate to elemental selenium or nitrogen gas, respectively.

### BRIEF DESCRIPTION OF THE FIGURES

FIG. 1 depicts a cross-sectional view of an exemplary rock pile having perforated nitrogen gas sparging pipes penetrating into the lower section of the pile.

FIG. 2 provides an exemplary 0.45 Power Maximum Density Curve, which can be referenced to determine the best gradation (i.e., particle size distribution) for materials of differing maximum particle (sieve) sizes.

### DETAILED DESCRIPTION

As used in the present specification, the following words, phrases and symbols are generally intended to have the meanings as set forth below, except to the extent that the context in which they are used indicates otherwise.

Open pit coal mining operations can produce massive quantities of waste rock. For example, the five mines in Elk Valley, British Columbia generate about 10 bank cubic meters (BCM) of waste rock for each metric ton of coal produced thereby resulting in approximately 250 million BCM (MBCM) of waste rock annually. The waste rock is typically dumped in adjacent waste rock piles that continue to grow for many decades throughout the life of the mine, sometimes reaching 100 meters in height or more. Because typical waste rock piles are porous and uncapped, they are subject to “weathering” whereby the infiltration of precipitation and the advection of air result in mineralization of the rock surfaces. For example, researchers have recently characterized the mineralogical and weathering reactions for the waste rock at the mines in the Elk Valley.

There are three primary chemical reactions that occur within the piles:
1. Pyrite Oxidation: FeS₂+15/4O₂+7/2 H₂O→Fe(OH)₃+2H₂SO₄
2. Siderite Oxidation: 4FeCO₃+O₂+10H₂O→4Fe(OH)₃+4H₂CO₃
3. Dolomite pH Buffering: CaMg(CO₃)₂+2H₂SO₄→Ca(HCO₃)₂+MgSO₄

Because the alkalinity production from carbonate minerals is high relative to the acid production from pyrite oxidation, the water leachate that drains from the bottom of the piles generally has a near neutral pH with “squeezed porewater” pHs ranging from 7.5 to 8.8 (mean of 8.2). This is referred to as “neutral rock leachate” to distinguish it from coal mining operations elsewhere that produce an “acid rock leachate.” The main anions in the leachate are sulfates and carbonates, and the main cations in the leachate are calcium and magnesium. Because of (1) the near neutral pH, and (2) ferrous iron from the oxidation of pyrite and siderite gets oxidized to the ferric valence, the iron precipitates as insoluble secondary ferric hydroxide or ferric oxyhydroxides and remains in the porewater zones of the rock piles. The leachate is thus free of significant concentrations of iron.

As the oxidation of pyrite minerals proceeds, trace amounts various elements are solubilized including selenium, arsenic, cadmium, and zinc. Fortunately, because of the near neutral pH and the precipitation of insoluble ferric hydroxide solids, most of the arsenic, cadmium and zinc solubilized remain within the rock pile by precipitation reactions and/or adsorption reactions onto the iron hydroxide solids (known as iron co-precipitation). Unfortunately, the leached selenium is in the form of selenate and not amenable to removal by iron-coprecipitation. Thus, it reports to the leachate at the bottom of the pile.

The rate at which selenium currently leaches from uncapped waste rock piles is governed mainly by the volume of rock exposed and the amount of water infiltrated from precipitation. For the mines in the Elk Valley, British Columbia, the overall average rate has been estimated to be about 1.6 Kg Se per Mbcm per year. It has been observed that each year the amount of selenium imposed on the downstream Elk River continues to increase as the volume of waste rock piles from the coal mining operations continues to increase. The elevated concentrations are of environmental concern because of adverse effects on reproduction of aquatic life.

Nitrate residuals from rock explosives cause a second environmental issue with the neutral rock leachate. The concentrations of nitrate-N in neutral rock leachate can be around 30 mg/L compared to only about 0.3 mg/L if selenium.

For the Elk Valley mines, one of the methods thus far developed for abating the selenium problem is the installation of “Active Water Treatment Facilities” (AWTFs) using anoxic biochemical reactors. For such facilities an easily degradable organic substrate such as glycerol is added to the bioreactor. During the course of degrading the glycerol, the bacteria in the reactor first consume the dissolved oxygen in the feed. After the dissolved oxygen has been consumed, the bacteria then use the chemically bound oxygen in nitrate for respiration. The nitrate is reduced to nitrogen gas. After the bacterial have depleted both the dissolved oxygen and nitrate concentrations, they continue to respire using the chemically bound oxygen in selenate. The selenate is biochemically reduced to elemental selenium and removed along with excess biomass. The amount of organic substrate to add thus depends on the concentrations of dissolved oxygen, nitrate-N and selenate in the raw water. Because the concentration of nitrate-N is very high relative to the concentration of selenate, the organic loading rate of the bioreactor is dominated by nitrates rather than selenium.

Although the AWTF technology is now reasonably well established as a variant of traditional denitrification, such facilities are very expensive to construct and operate in part because their size, capacity and costs are largely governed by the amount of nitrate-N to remove rather than the amount of selenium to remove. Pretreatment of the leachate for partial reduction of nitrates alone or partial reduction of both nitrates and selenates, would serve to make application of anoxic biological AWTFs more cost-effective and wide spread.

Investigators working on the Elk Valley selenium problem have recently shown via bench tests and full-scale trials that the same biochemical reactions that take place in compact biological reactors can also be accomplished in large pits of waste rock flooded with leachate, referred to herein as saturated waste rock reactors (SWRR). Surprisingly, bench testing experiments conducted by researchers has shown that addition of an organic substrate is not necessary for biochemical reduction of nitrates alone or together with selenium depending on the degree of anoxic conditions. Conceivably, the saturated rock process could be applied as a pretreatment process to reduce the load imposed on a given AWTF thereby expanding capacity. Concerns, however, include freezing, variable effluent quality and space requirements.

An underlying problem with the concept of AWTFs and SWRRs is that over time more and more facilities are needed in order to keep up with the increased rate of selenium and nitrates leaching from the ever-increasing total volume of waste rock piles. In view of this problem, Applicants have devised a rock pile in situ method that reduces nitrates alone or both nitrates and selenates within the rock pile so that the concentrations in the leachate fed to the AWTF are much lower or, in some embodiments, substantially eliminated. In this way the loading imposed on an AWTF can be controlled to a relatively constant rate as the total volume of rock continues to increase throughout the life of the mine.

The methods described herein have advantages over prior methods implemented. For example, traditional methods for attenuating either acid rock drainage or neutral rock drain generally attempt to inhibit the oxidation rate of iron pyrite by (1) constructing some type of impermeable cover to prevent the advection of oxygen into the pile; or (2) adding chemicals to the rock pile that result in the formation of an inorganic, organic, or biomass barrier over the rock surface that serves to block the pyrite oxidation reaction. The latter known as “passivation” or “armoring.” Although covers may be practical as part of the plan for end-of-mine closure, they are especially difficult and expensive to construct and subject to failure as more rock is added during decades-long operation periods. For the armoring approach, the addition of chemicals on such a massive scale carries a major environmental risk to the watershed should any of the reagent(s) added bleed out of the pile.

Moreover, because the length of time it takes for water to travel downward by unsaturated flow can be on the order of a decade for tall piles, the response time associated with covers and armoring would be too long to be of practical value. In other words, the quality of the leachate at the bottom of the rock pile would remain essentially unchanged for many years after covering or armoring because the downward travel of unsaturated water flow is very slow. Methods for trying to stop leachate volume production and/or the pyrite oxidation reaction are thus ineffective during the period of operation as the volume of the rock pile continues to increase.

The exemplary in situ methods described herein overcome such issues by reducing selenates and/or nitrates in the leachate after they have been formed within the pile. Such methods solve both the delayed response problem associated with methods for inhibiting the oxidation reaction, while at the same time reduce the loadings imposed on active water treatment systems to make them more cost-effective. Therefore, in certain embodiments the methods can exclude the use of covers or other passivation methods. Nevertheless, in certain embodiments the methods may be implemented on rock piles having covers or other passivation/armoring systems.

The instant disclosure describes methods of treating leachates in a rock pile. In certain embodiments, the method comprises:

identifying a site having a rock pile with a top, a bottom, an upper section, and a lower section, said lower section containing oxygen, bacteria, and an aqueous leachate, wherein the aqueous leachate comprises at least one of a selenate or a nitrate, and wherein the bacteria are indigenous to the site;

displacing the oxygen from at least a portion lower section of the rock pile; and

allowing the bacteria to reduce the at least one selenate or nitrate to selenium or nitrogen, respectively.

Importantly, it should be understood that the methods described herein may be applied to “active” piles in which new rock waste material is still being added to the rock pile. However, in certain embodiments the systems and methods can be implemented on “inactive” piles for which addition of new rock material is no longer taking place. In certain embodiments, the site comprises a mining operation, such as a coal mining operation, wherein the rock pile comprises a waste rock pile derived from the mining process. Depending on the source of the rock pile, the mineral makeup of the rock pile may differ from location to location, wherein the resulting aqueous leachate is acidic, neutral, or basic. In certain embodiments, the leachate is neutral in nature and exhibits a pH of, e.g., about 7 to about 9, such as about 7.5 to about 8.8.

In certain embodiments, the method may be implemented so as to lower the loadings of selenate and/or nitrates imposed on the external anoxic biochemical active water treatment facilities (AWTF) and thereby make them more cost-effective. Another aspect is to reduce the long delay in response times associated with traditional concepts for preventing or inhibiting the generation of neutral rock drainage.

In certain embodiments, the essence of the disclosed methods herein may be described as anoxic unsaturated water biochemical reactor (AUWBR) located within the lower section of the pile (e.g., near the bottom) of the pyrite oxidation zone within the waste rock pile. The “reactor” is created by the introduction of inert gas (e.g., nitrogen) to purge the area of oxygen so as to create an anoxic environment. The anoxic environment enables the proliferation of indigenous species of nitrate-reducing and selenate-reducing bacteria. Such species can derive their energy from inorganic substrates such as manganese, iron and sulfides naturally available from the neutral rock leaching reactions and cellular carbon from bicarbonate ion. Accordingly, in certain embodiments, the addition of an external organic substrate is not needed.

In certain embodiments, the environmental conditions inside waste rock piles containing neutral rock leachate are in many ways ideal for in situ biochemical treatment. Because the oxidation of pyrite minerals is an exothermic reaction, and because of natural insulation by the rock materials, the temperatures deep in the rock pile can be well above the 10° C. criterion designers typically use for anoxic biological removal of nitrates and selenates in engineered facilities. For example, it has been shown that temperatures inside the pile at a depth of about 62 meters and lower can remain at around 13-14° C. throughout the year except during January and February when rock pore temperatures dips.

Indigenous species of bacteria are present in waste rock piles can be effectively used to reduce nitrate to nitrogen gas without the addition of an external organic substrate, provided anoxic conditions were established. Although a counterpart species for selenate removal was not found in the waste rock, both categories of species (e.g., nitrate reducers and selenate reducers) were found in the leachate water from the rock pile.

In certain embodiments, reduction of selenate may require strict anoxic conditions. In certain embodiments, depending on the location of the site, the predominant genera of bacteria may include one or more of Albidiferax spp., Polaromonas spp., Thiobacillus spp., and Sulfuritalea spp. In other embodiments, the bacteria may comprise chemolithotrophs. Some of these species have the capability to reduce nitrates while getting their energy from oxidation of manganese, iron or reduced sulfur species. Microbial synthesis of cellular carbon presumably comes from the bicarbonates in the leachate. Notably, in certain embodiments, the addition of an external organic substrate and nutrients such as phosphorus was not required. In other embodiments, the bacteria can be supplemented via seeding with bacteria derived from an external source.

Research has demonstrated that unlike rock piles, the small particle size range of the coal rejects can prevent the advection of air and thus enable anoxic conditions to prevail inside the waste pile. This may allow indigenous species to effectively remove selenate without the need for external addition of an organic substrate or nutrients such as phosphorus. Other research has demonstrated that the differential pressure of the gas inside the void spaces of deep rock piles stays positive during the six colder months of the year and slightly negative during the warmer six months. The positive pressures during the colder months are the result of warmer gas temperatures inside the pile compared to outside ambient temperatures. During this period the gas within the internal region of the rock pile tends to flow upward and outside air tends to enter from the base. During summer months the reverse can occur with external air entering from the top and internal gases exiting the bases.

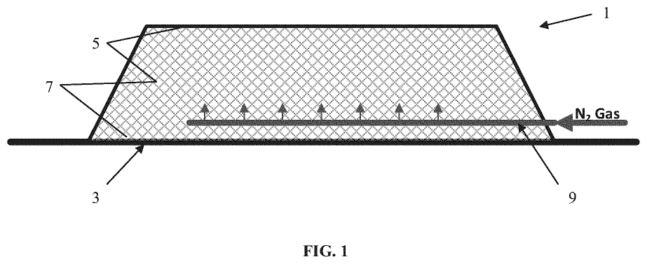

In certain embodiments, the methods described herein are implemented to treat leachates at the lower section of the rock pile. FIG. 1 provides an exemplary cross-sectional view of a hypothetical rock pile having top 1, bottom 3, which define upper section 5 and lower section 7. Perforated pipes 9 horizontally penetrate the lower section 7 of the rock pile, which allows for the introduction of nitrogen towards the bottom 3 of the pile and, thus, allowing the nitrogen to displace gases such as oxygen that may be present in the lower section 7 of the pile to provide anoxic conditions.

Thus, in certain embodiments the method comprises displacing oxygen by injecting an inert gas such as nitrogen into the lower section of the rock pile. In certain embodiments, the injecting comprises sparging the inert gas into perforated pipes penetrating the lower section of the rock pile. Exemplary “perforated pipes” may include any conduit-type of system that is capable of introducing the inert gas to the inside of the lower section of the rock pile, e.g., a system wherein the inside of the rock pile is in fluid/gaseous communication with inert gas source. For example, the pipe systems may include slotted elastomeric bladders, similar to those used for bubble diffusion in wastewater treatment plants. In certain embodiments, the perforated pipes penetrate the lower section of the rock pile horizontally. In certain embodiments, the lower section of the pile is defined to be the portion of the pile from the bottom to a position that is halfway between the bottom and the top. In certain embodiments, the inert gas is introduced to the lower section of the rock pile at a location that is closer to the bottom than the position halfway between the bottom and the top. In certain embodiments, the inert gas may dry out the areas around the pipes inside the pile, inhibiting the activity of the bacteria. Accordingly, in certain embodiments the inert gas may be introduced in a humidified form.

As noted above, in some of the embodiments described herein the method of treating leachate that has made its way to the lower section of an unsaturated rock pile. Thus, in such embodiments, the method of remediating selenates and nitrates from the waste rock is focused on treating leachates after formation, as opposed to reducing or eliminating leachate formation altogether. Therefore, in certain embodiments, the method may comprise one in which leachate formation is reduced or eliminated altogether. This may be accomplished, for example, by reducing the resulting porosity within the rock pile during the initial rock pile formation.

For example, in certain embodiments the method may comprise initially forming the rock pile, such as from waste rock from a mining operation, in a manner that will reduce or eliminate the infiltration of water and air into the resulting pile. In certain embodiments, this may be accomplished by crushing the waste rock to effect tight packing of the rock material when forming the pile, which will reduce the volume of voids in the resulting pile. In certain embodiments, the crushing may be accomplished by at least one of a jaw crusher, cone crusher (e.g., spring or hydraulic), hammer crusher, or a vertical shaft impactor.

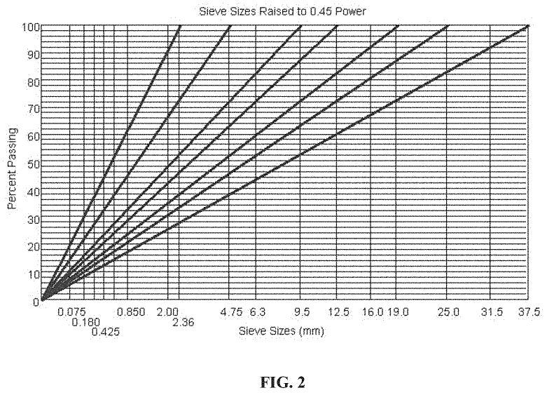

In certain embodiments, the method comprises crushing the rock with reference to its hypothetical Maximum Density Line, and packing the crushed rock to form a rock pile. FIG. 2 provides an exemplary 0.45 Power Maximum Density Curve, which can be referenced to determine the best gradation (i.e., particle size distribution) for materials of differing maximum particle (sieve) size. In certain embodiments, the rock will be crushed to achieve a “dense” gradation, in which the particle distribution closely tracks the Maximum Density line. The crushed rock will then be packed to form the rock pile. Assuming a dense gradation, the voids in the resulting rock pile will be reduced greatly and, thus, limit the permeation of air and water into the rock pile. This will consequently reduce the formation of leachates in the pile and, thus, reduce or eliminate the presence of selenate and/or nitrate-containing leachates in the lower section of the pile.

In certain embodiments, the resulting rock pile will exhibit a void volume of less than 10%, less than 8%, less than 5%, or even less than 1%. In certain embodiments, the rock pile exhibits a void volume of about 0.1 to about 5%, such as about 0.5 to about 3%. In certain embodiments the pile exhibits a void volume of about 0.5%, 1.0%, 1.5%, 2%, 2.5%, 3%, 3.5%, 4%, 4.5%, or even 5%. Depending on the gradation of the crushed material, it may be desirable to add a “filler” to further reduce the voids and/or oxidation potential of the components in the material of the resulting rock pile. Exemplary fillers may include, but are not limited to, ferrous sulfide, ferric chloride, Fe⁰, hydroxides such as aluminum hydroxide or ferric hydroxide (e.g., derived from sludges from water treatment processes), carbonates such as calcium or magnesium carbonate (e.g., derived from sludges from lime softening water treatment operations), and other mineral fillers (e.g., quarry derived).

### EXAMPLES

### Example 1

Consider a neutral rock waste pile having a total volume of 100 million cubic meters with a length of 1,000 meters, a width of 500 meters and a height of 200 meters. Assume the void volume is 25%. The hot zone where the exothermic oxidation reactions occur begins about 60 meters down and extends to the bottom of the rock pile. Assuming about 600 mm of net annual infiltration into the rock pile and a typical volumetric water content of 8%, it may be computed that the migration rate of water by unsaturated flow is only about 7.5 meters per year. Thus, for this example it takes over 13 years for infiltrated water to reach the bottom of the rock pile as leachate.

If the spacing of the individual injection lines is selected to be about 15 meters, the application during a given year would essentially last the equivalent of two years of downward travel of the leachate. Thus, only about half of the waste rock pile would need to be treated each year, i.e., about 500 meters of the rock pile length. Considering each reactor zone covers about 15 meters of length, then 33 batch treatment zones would be needed each year (500/15=33). Assuming a 2 week batch reaction time is selected for removal of nitrates alone, and that operation of the batch reactors is restricted to the warmer months of the year, then two cells would probably need to be operated together. Thus, every two weeks a new pair of horizontal reactors would be started and the previous two shut down.

The quantity of nitrogen gas needs may be computed based on the assumption of plug flow of the gas as it expands outward to form a horizontal tube having a diameter of 15 meters. If each of the reactors is 500 meters long and the rock void volume is 25%, then the amount of nitrogen gas to fill the void space is equivalent to about 22,100 m³. This could be accomplished is one day at a gas feed rate of 921 m³ per hour. Assuming a maintenance gas flow rate of 15% per day is need to maintain anoxic conditions within the 15-meter diameter reactor, and a reaction time of 13 days, the total volume of nitrogen gas needed for a single reactor would be about 71,800 m³. Over the course of the injection “season” the total volume of nitrogen gas needed would be approximately 33×71,800 or 2,225,800 m³. At a unit cost of $0.10 cubic meter for nitrogen gas, the annual cost would total around $222,600. It is believed this cost would be very attractive because the reduction in nitrate loading otherwise imposed on the downstream anoxic Active Water Treatment would eliminate the need for constructing and operating a second AWT facility.

### Embodiments

1. A method comprising:
identifying a site having a rock pile with a top, a bottom, an upper section, and a lower section, said lower section containing oxygen, bacteria, and an aqueous leachate, wherein the aqueous leachate comprises at least one of a selenate or a nitrate, and wherein the bacteria are indigenous to the site;
displacing the oxygen from at least a portion of the lower section of the rock pile; and
allowing the bacteria to reduce the at least one selenate or nitrate to elemental selenium or nitrogen gas, respectively.

2. The method of embodiment 1, wherein the site comprises a mining operation.

3. The method of embodiment 2, wherein the rock pile is a waste rock pile derived from a mining operation.

4. The method of embodiments 2-3, wherein the mining operation comprises a coal mining operation.

5. The method according to any of the preceding embodiments, wherein the aqueous leachate comprises a pH of about 7 to about 9.

6. The method according to any of the preceding embodiments, wherein the aqueous leachate comprises a pH of about 7.5 to about 8.8.

7. The method according to any one of the preceding embodiments, wherein the indigenous bacteria are selected from at least one of Albidiferax spp., Polaromonas spp., Thiobacillus spp., or Sulfuritalea spp.

8. The method according to any of the preceding embodiments, wherein displacing the oxygen comprises injecting an inert gas into the lower section of the rock pile.

9. The method of embodiment 8, wherein the inert gas comprises nitrogen.

10. The method according to embodiments 8-9, wherein the injecting comprises sparging the inert gas into perforated pipes penetrating the lower section of the rock pile.

11. The method of embodiment 10, wherein the perforated pipes penetrate the lower section of the rock pile horizontally.

12. The method of any of the preceding embodiments, wherein the lower section of the rock pile extends from the bottom to a position halfway between the bottom and the top.

13. The method of embodiment 12, wherein displacing the oxygen comprises introducing an inert gas into the lower section of the rock pile.

14. The method of embodiment 13, wherein the inert gas is introduced to the lower section of the rock pile at a location that is closer to the bottom than the position halfway between the bottom and the top.

15. The method of any one of embodiments 8-14, wherein the inert gas comprises a humidified inert gas.

16. The method of any one of the preceding embodiments, wherein the method excludes the use of a cover on the top of the pile.

17. The method of any one of embodiments 1-15, wherein the method excludes the use of passivation or armoring.

18. A method comprising:
identifying a waste rock material;
crushing the waste rock to produce crushed waste rock; and
packing the crushed waste rock to form a rock pile, wherein the rock pile exhibits a void volume of 5% or less.

19. The method of embodiment 18, wherein the waste rock material comprises coal mining waste rock.

20. The method of any of embodiments 18-19, wherein the waste rock is crushed by at least one of a jaw crusher, cone crusher, hammer crusher, or a vertical shaft impactor.

21. The method of any one of embodiments 18-20, wherein the rock pile exhibits a void volume of about 0.1 to about 5%.

22. The method of any one of embodiments 18-20, wherein the rock pile exhibits a void volume of about 0.5 to about 3%.

23. The method of any one of embodiments 18-22, wherein the rock pile further comprises a filler.

24. The method of any one of embodiments 18-22, further comprising mixing the crushed waste rock with at least one filler.

25. The method of any one of embodiments 23-24, wherein the filler is selected from at least one of ferrous sulfide, ferric chloride, Fe⁰, aluminum hydroxide, ferric hydroxide, calcium carbonate, magnesium carbonate, or quarry minerals.

26. The method of any one of embodiments 1-17, wherein the rock pile is derived from a process comprising the method of any one of claims 18-25.

27. The method according to any one of embodiments 1-17, wherein the indigenous bacteria are chemolithotrophic.

28. The method according to any one of embodiments 1-16, wherein the rock pile comprises a cover on top of the pile.

29. The method according to any one of the preceding embodiments, wherein the rock pile is in active use.

30. The method according to any one of embodiments 1-28, wherein the rock pile is not in active use.

1. A method comprising:
identifying a site having a rock pile with a top, a bottom, an upper section, and a lower section, said lower section containing oxygen, bacteria, and an aqueous leachate, wherein the aqueous leachate comprises at least one of a selenate or a nitrate, and wherein the bacteria are indigenous to the site;
displacing the oxygen from at least a portion of the lower section of the rock pile; and
allowing the bacteria to reduce the at least one selenate or nitrate to elemental selenium or nitrogen gas, respectively.

2. The method of claim 1, wherein the site comprises a mining operation.

3. The method of claim 2, wherein the rock pile is a waste rock pile derived from a mining operation.

4. The method of claim 2, wherein the mining operation comprises a coal mining operation.

5. The method according to claim 1, wherein the aqueous leachate comprises a pH of about 7 to about 9.

6. The method according to claim 1, wherein the aqueous leachate comprises a pH of about 7.5 to about 8.8.

7. The method according to claim 1, wherein the indigenous bacteria are selected from at least one of Albidiferax spp., Polaromonas spp., Thiobacillus spp., or Sulfuritalea spp.

8. The method according to claim 1, wherein displacing the oxygen comprises injecting an inert gas into the lower section of the rock pile.

9. The method of claim 8, wherein the inert gas comprises nitrogen.

10. The method according to claim 8, wherein the injecting comprises sparging the inert gas into perforated pipes penetrating the lower section of the rock pile.

11. The method of claim 10, wherein the perforated pipes penetrate the lower section of the rock pile horizontally.

12. The method of claim 1, wherein the lower section of the rock pile extends from the bottom to a position halfway between the bottom and the top.

13. The method of claim 12, wherein displacing the oxygen comprises introducing an inert gas into the lower section of the rock pile.

14. The method of claim 13, wherein the inert gas is introduced to the lower section of the rock pile at a location that is closer to the bottom than the position halfway between the bottom and the top.

15. The method of claim 8, wherein the inert gas comprises a humidified inert gas.

16. The method of claim 1, wherein the method excludes the use of a cover on the top of the pile.

17. The method of 1, wherein the method excludes the use of passivation or armoring.

18. A method comprising:
identifying a waste rock material;
crushing the waste rock to produce crushed waste rock; and
packing the crushed waste rock to form a rock pile, wherein the rock pile exhibits a void volume of 5% or less.

19. The method of claim 18, wherein the waste rock material comprises coal mining waste rock.

20. The method of claim 18, wherein the waste rock is crushed by at least one of a jaw crusher, cone crusher, hammer crusher, or a vertical shaft impactor.

21. The method of claim 18, wherein the rock pile exhibits a void volume of about 0.1 to about 5%.

22. The method of claim 18, wherein the rock pile exhibits a void volume of about 0.5 to about 3%.

23. The method of claim 18, wherein the rock pile further comprises a filler.

24. The method of claim 18, further comprising mixing the crushed waste rock with at least one filler.

25. The method of claim 23, wherein the filler is selected from at least one of ferrous sulfide, ferric chloride, Fe⁰, aluminum hydroxide, ferric hydroxide, calcium carbonate, magnesium carbonate, or quarry minerals.

26. The method of claim 1, wherein the rock pile is derived from a process comprising the method of claim 18.

27. The method according to claim 1, wherein the indigenous bacteria are chemolithotrophic.

28. The method according to claim 1, wherein the rock pile comprises a cover on top of the pile.

29. The method according to claim 1, wherein the rock pile is in active use.

30. The method according to claim 1, wherein the rock pile is not in active use.
